(19) United States
(12) Patent Application Publication
(10) Pub. No.: US 2007/0045419 A1
(43) Pub. Date: Mar. 1, 2007

(54) Appendage based user interface navigation system for imaging devices

(76) Inventors: Edwin A. Hernandez, Coral Springs, FL (US); Kenny R. Ardizzone, Plantation, FL (US)

Correspondence Address: CUENOT & FORSYTHE, L.L.C., 12230 FOREST HILL BLVD., SUITE 120, WELLINGTON, FL, 33414, US

(21) Appl. No.: 11/216,264

(22) Filed: Aug. 31, 2005

(51) Int. Cl. G06K 7/10

(52) U.S. Cl. 235/454

(57) ABSTRACT

An imaging device (100) having an imaging system (102) that optically detects movement of an appendage (104), and a processor (200) that automatically translates the movement of the appendage to alphanumeric symbols (400) or graphical user interface navigation commands. The processor can automatically implement the alphanumeric symbols or navigation commands in an application (208). In addition, the processor can automatically identify a second alphanumeric symbol (502) that has a high statistical probability of following a first alphanumeric symbol (500). The processor also can detect a speed at which the appendage is moved and generate a motion parameter correlating to the detected speed. The processor can process the motion parameter to automatically translate the movement of the appendage. The processor can correlate the motion parameter to a user interface scroll speed.

### BACKGROUND OF THE INVENTION

1. Field of the Invention

The present invention generally relates to handheld devices and, more particularly, to handheld devices that include image capture systems.

2. Background of the Invention

Consumers continue to demand mobile telephones that are full featured portable devices, yet are inexpensive and simple to use. Mobile telephones generally include small keypads, however, which for some users are difficult to use. Moreover, additional buttons are sometimes provided to implement special features, but use of the additional buttons can be confusing. Implementation of additional buttons also increases the manufacturing cost of the mobile telephones. Thus, although the range of features that are provided with mobile telephones continues to increase, their remains a need to simplify their use and reduce their cost.

### SUMMARY OF THE INVENTION

The present invention relates to an imaging device having an image capture system. The device can include an imaging system that optically detects movement of an appendage, and a processor that automatically translates the movement of the appendage to alphanumeric symbols or graphical user interface navigation commands. In addition, the processor can automatically implement the alphanumeric symbols or navigation commands in an application.

The processor also can automatically identify a second alphanumeric symbol in response to translating the movement of the appendage to a first of the alphanumeric symbols. For example, the processor can automatically identify a second alphanumeric symbol that has a high statistical probability of following the first alphanumeric symbol. Further, the processor can change the second alphanumeric symbol to an alphanumeric symbol that correlates at least one additional movement of the appendage that is optically detected by the imaging system.

The processor also can detect a speed at which the appendage is moved and generate a motion parameter correlating to the detected speed. The processor can process the motion parameter to automatically translate the movement of the appendage. The processor can correlate the motion parameter to a user interface scroll speed.

The invention also relates to a method for controlling a device having an image capture system. The method can include the steps of optically detecting movement of an appendage, automatically translating the movement of the appendage to alphanumeric symbols or graphical user interface navigation commands, and automatically implementing the alphanumeric symbols or navigation commands in an application.

Responsive to translating the movement of the appendage to a first of the alphanumeric symbols, a second alphanumeric symbol can be automatically identified. For example, based on the first alphanumeric symbol, a second alphanumeric symbol that has a high statistical probability of following the first alphanumeric symbol can be automatically identified. Responsive to optically detecting at least one additional movement of the appendage, the second alphanumeric symbol can be changed to an alphanumeric symbol that correlates to the additional movement.

The method also can include detecting a speed at which the appendage is moved, and generating a motion parameter correlating to the detected speed at which the appendage is moved. The step of automatically translating the movement of the appendage can include processing the motion parameter. The step of automatically translating the movement also can include correlating the motion parameter to a user interface scroll speed.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts an imaging device that is useful for understanding the present invention.

FIG. 2 depicts a block diagram of the imaging device of FIG. 1.

FIG. 3 depicts motion vectors that are useful for understanding the present invention.

FIG. 4 depicts alphanumeric symbols and associated motion vectors that are useful for understanding the present invention.

FIGS. 5A-5E present a sequence of graphical user interface views which are useful for understanding the present invention.

FIG. 6 is a flowchart that is useful for understanding the present invention.

FIG. 7 is another flowchart that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for translating movements of an appendage, such as a finger or thumb, into commands that can be processed by an application. For example, the method and system can be implemented in a mobile device having an image processing system, such as a camera, to translate movement of the appendage into alphanumeric symbols or user interface navigation commands. Accordingly, a user of such a device is not limited to using keypads and buttons for entering text, numbers and commands into the device.

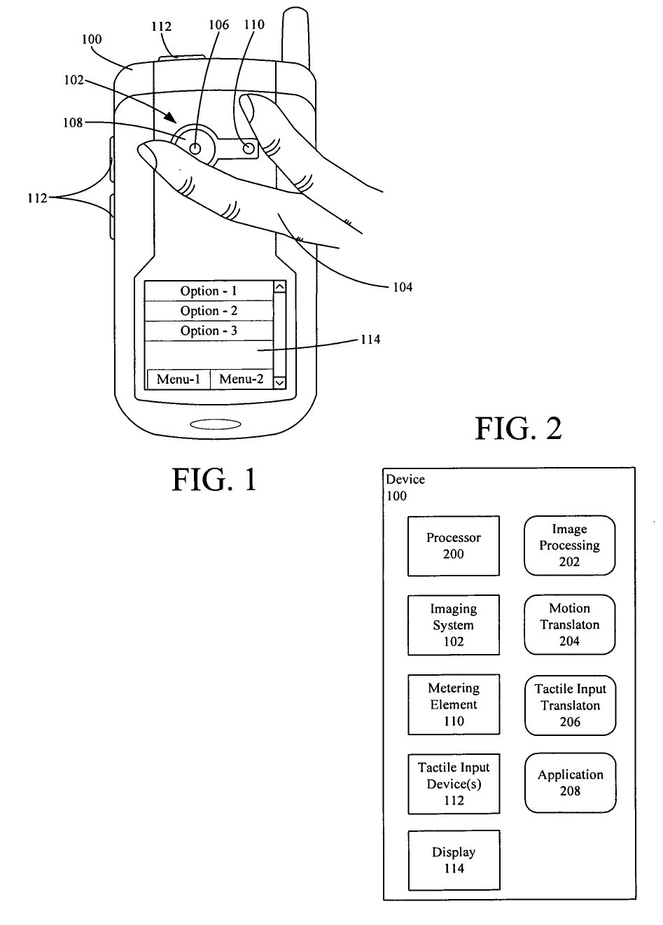

FIG. 1 depicts a device 100 that is useful for understanding the present invention. The device 100 can be mobile telephone, a camera, or any other device having an imaging system 102 for optically detecting movement of an appendage 104. The imaging system 102 can include an image sensor 106. Examples of suitable image sensors include a charge-coupled device (CCD) and a complementary metal oxide semiconductor (CMOS) sensor, although the invention is not limited in this regard. The imaging system 102 also can include imaging optics 108, such as a lens.

In contrast to a touchpad, which typically requires direct contact of an appendage to detect movement, the imaging system 102 can detect movement of the appendage 104 without direct contact between the appendage 104 and the imaging system 102. In particular, the lens 108 can direct photons received from the appendage 104 to the image sensor 106, which can generate digital image data. The digital image data then can be processed to detect motion of the appendage 104.

The device 100 also can include a metering element 110. The metering element 110 can be used to detect ambient light levels to generate ambient light data useful for image processing. In addition, the metering element 110 can be used to detect user inputs. For instance, the metering element 110 can be covered by the appendage 104 to enter a user input, for example when the user chooses to activate or deactivate motion detection. Specifically, data generated by the metering element 110 can be processed to determine when an amount of light detected by the metering element 110 changes. Nonetheless, other input devices also can be used to receive user inputs. For example, user inputs can be received via the tactile input devices 112, a key pad (not shown), or any other suitable user input device.

The device 100 also can include a display 114. The display 114 can be used to present a graphical user interface (GUI) to a user. For instance, the display 114 can be used to present menus of selectable items, messages, or other information to the user. In one arrangement, the display 114 can include a touch screen for receiving tactile inputs.

FIG. 2 depicts a block diagram of the device 100. In addition to the imaging system 102, metering element 110, tactile input devices 112 and display 114 previously described, the device 100 also can include a processor 200. The processor 200 can include a central processing unit (CPU), a digital signal processor (DSP), an application specific integrated circuit (ASIC), a programmable logic device (PLD), and/or any other suitable processing device. The processor 200 can process application data and data generated by the various input devices 102, 110, 112. For instance, if motion detection has been activated on the device, the processor 200 can process the image data generated by the imaging system 102 to implement the processes described herein.

One or more software modules can be accessed by the device 100 for execution by the processor 200. For instance, an image processing module 202, a motion translation module 204, a tactile input translation module 206 and an application 208 can be provided.

In operation, the processor 200 can execute the image processing module 202 to process image data received from the imaging system 102, and correlate the image data to specific motion vectors. The processor 200 then can execute the motion translation module 204 to translate the motion vectors into alphanumeric symbols or specific application commands. For example, the processor 200 can translate the motion vectors into commands for controlling the user interface. The processor 200 also can execute the tactile input translation module 206 to translate tactile inputs, such as those received via the tactile input devices 112, into alphanumeric symbols and/or commands.

The alphanumeric symbols and/or commands generated by execution of the translation modules 204, 206 can be processed during execution the application 208. For example, if the application 208 is a text editor, alphanumeric text generated by the image translation module 204 can be entered into the text editor. In addition, commands generated by the image translation module 204 can be used to control the application 204. For instance, the commands can be used to implement GUI control features, such as scrolling, implement file operations, such as file save, file open, etc., or implement any other application functions.

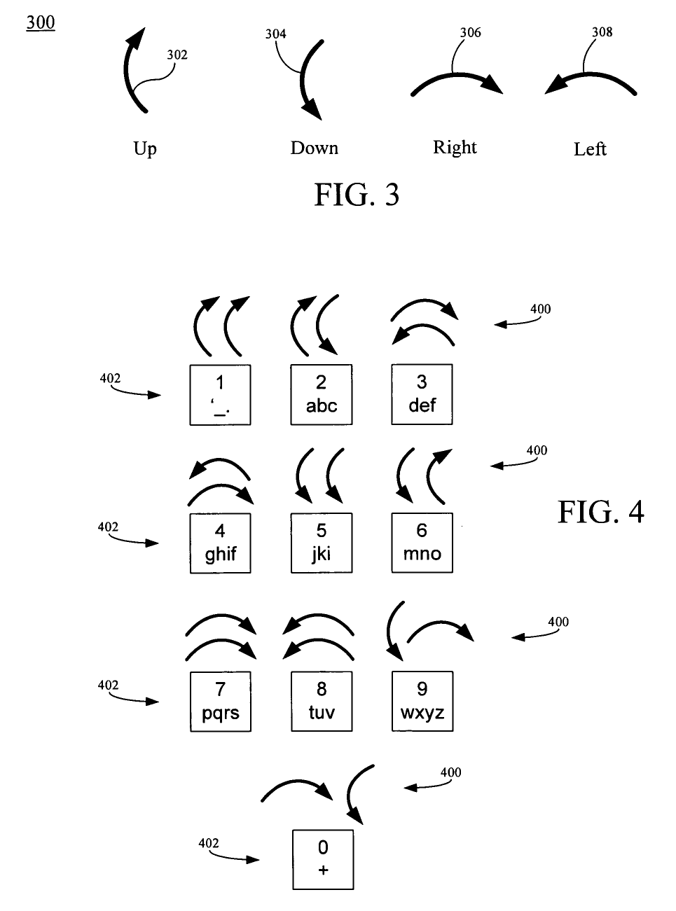

Referring to FIG. 3, motion vectors 300 that are useful for understanding the present invention are shown. The motion vectors 300 can represent specific appendage motions that are used to enter data into the device. For example, an “up” motion vector 302 can represent a generally upward motion of the appendage, a “down” motion vector 304 can represent a generally downward motion of the appendage, a “right” motion vector 306 can represent a generally rightward motion of the appendage, and a “left” motion vector 308 can represent a generally left motion of the appendage. In the arrangement depicted, the motion vectors 300 can be defined to have a path that is substantially arc shaped to closely represent natural movement of a human appendage, such as a thumb or finger, as the appendage passes the imaging system. However, the invention is not limited in this regard. For example, the motion vectors can be straight, or have any other defined path shape.

In addition to the shape of the motion vectors 300 that are used, the relative speed at which the appendage is moved in the view of the image detector can be processed to implement device commands. For example, the processor can compute the relative distance the appendage has moved between sequential images and the time difference between the sequential images. Based on the relative distance and time difference, the processor can compute a relative appendage speed and generate a correlating motion parameter.

If the appendage movements are being used to implement scroll functions within a view of a GUI, the speed at which the view scrolls can correlate to the motion parameter, and thus the speed of the appendage movement. For instance, the appendage can be slowly moved across the view of the image detector to implement a slow scroll, and the appendage can be quickly moved across the view of the image detector to implement a fast scroll. Still, the speed at which the appendage is moved can be used to control other device parameters or implement other device commands, and such operation is within the scope of the present invention.

Referring to FIG. 4, examples of motion vectors 400 which can be associated with the alphanumeric symbols 402 are shown. For instance, two downward motion vectors can correlate to the number “5”, and the letters “j,” “k” and “l.” Accordingly, two sequential movements of the appendage in the view of the image detector in a path defined by the downward motion vectors can be implemented to select “5.”

In one arrangement, only movements that occur within a defined time period will be considered to be sequential. For instance, the defined time period can be 800 milliseconds. Thus, two movements that occur within 800 milliseconds can be considered to be sequential movements that are processed to select an alphanumeric symbol 402, while movements that occur farther apart in time can be considered to be independent movements. Of course, 800 milliseconds is just an example of a time period that can be defined, and the invention is so limited. Indeed, in one arrangement the defined time period can be a user selectable option.

After the first sequence of movements has been used to select a symbol, another movement of the appendage in the view of the image detector, for instance a movement in the up direction, can be implemented to sequentially scroll through the other noted symbols. For example, after the number “5” has been selected, and the defined time period has elapsed since the selection, another movement in the up direction can be implemented to scroll to the letter “j.” Another movement in the up direction can be implemented to scroll to the letter “k,” and so on. Once an alphanumeric symbol has been selected, another movement can be implemented to select a second alphanumeric symbol, and the process can repeat.

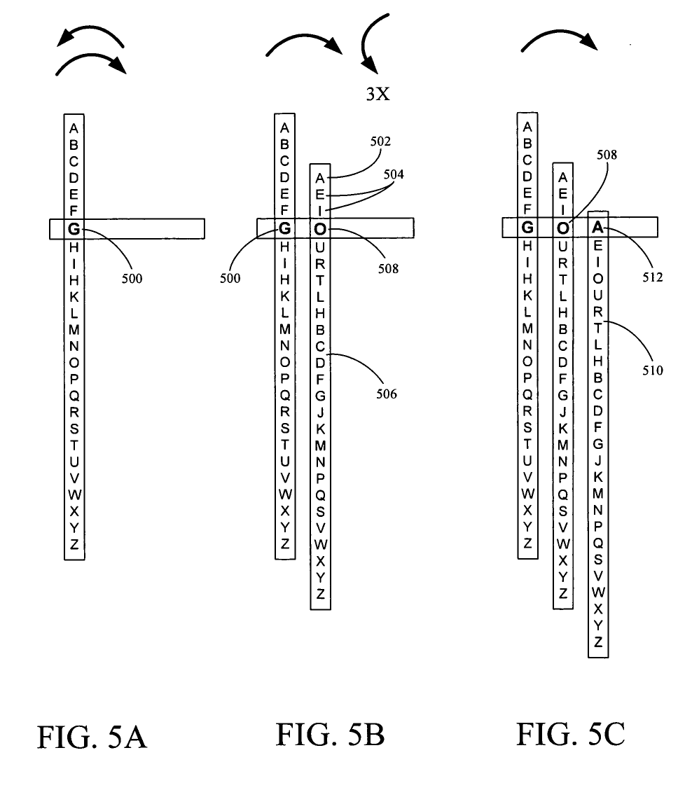

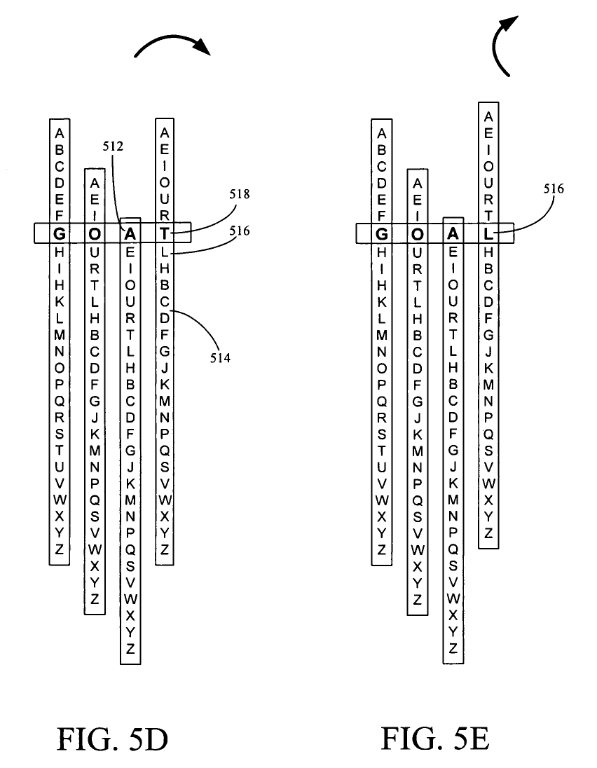

FIGS. 5A-5E present a sequence of graphical user interface views which are useful for understanding the process of generating text using the alphanumeric symbol selection process described herein. Beginning at FIG. 5A, the appendage can be sequentially moved left, then right, passed the image detector to select a first letter 500 of a desired word, for example the letter “G.” Referring to FIG. 5B A movement of the appendage to the right then can be used to indicate that a next symbol is to be selected.

In one embodiment of the present invention, the application in which the text is being selected can include an algorithm that automatically identifies a next alphanumeric symbol 502 based on statistical probabilities. Other alphanumeric symbols 504 that may follow the first symbol 500 can be provided in a list 506 in descending order below the identified alphanumeric symbol 502. The order in which the other alphanumeric symbols 504 are listed can be based on probabilities. For example, if the letter “A” 502 has a high probability of following the letter “G,” the letter “A” 502 can be automatically identified and placed at the top of the list 506. In this example, however, the letter “A” 502 is not the next symbol that is desired. Thus, the appendage can be moved in the view of the image detector in a downward direction to scroll down the list 506 of symbols until the desired symbol “O” 508 is identified.

Referring to FIG. 5C, a movement of the appendage to the right can be used to select the presently identified symbol 508 as the next symbol, and a third list of symbols 510 can be presented. In this example, the symbol 512 that is automatically identified is the desired symbol “A.”

In FIG. 5D, a movement of the appendage to the right can again be implemented to select the symbol 512 and present a fourth list of symbols 514. In the fourth list 514, the desired letter “L” 516 is listed below the automatically identified letter “T” 518. Accordingly, referring to FIG. 5E, a movement of the appendage in the upward direction can be used to identify the letter “L” 516 as the desired letter. Another pre-defined appendage movement in the view of the image detector or a tactile input can be entered into the device to complete the word selection, and the process can be repeated to select a next word.

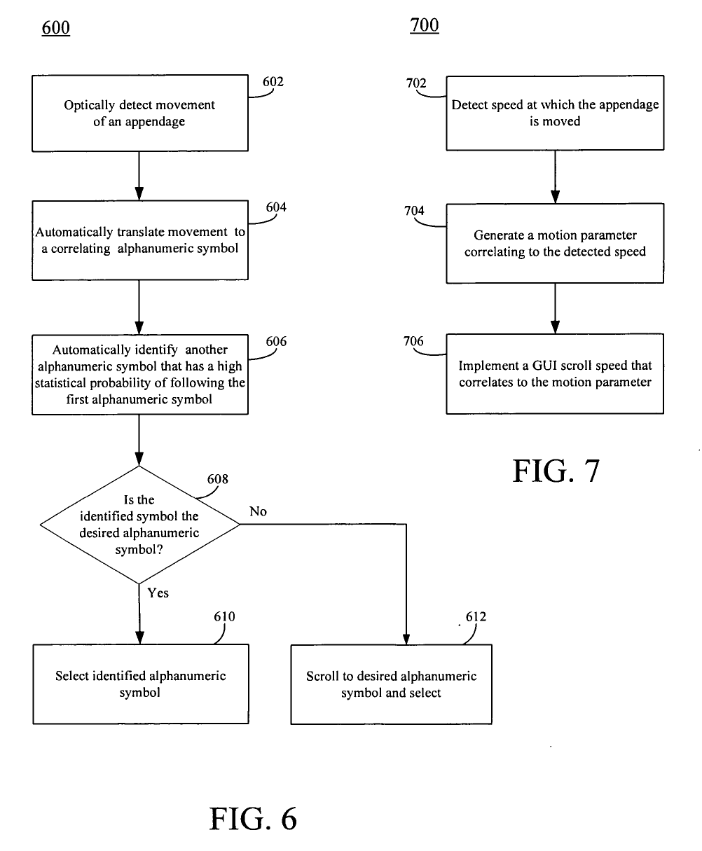

FIG. 6 is a flowchart that presents a method 600 which is useful for understanding an aspect of the present invention relating to selection of alphanumeric symbols. Beginning at step 602, movement of an appendage in the view of an image detector can be optically detected. At step 604, the movement can be automatically translated to an alphanumeric symbol. Continuing to step 606, an alphanumeric symbol that has a high statistical probability of following the first alphanumeric symbol can be automatically identified. Referring to decision box 608 and step 610, if the identified symbol is the desired alphanumeric symbol, the identified alphanumeric symbol can be selected. Alternatively, if the identified symbol is not the desired alphanumeric symbol, user inputs can be received to scroll to the desired alphanumeric symbol and that symbol can be selected, as shown in step 612. If another symbol is to be selected, the process can repeat at step 602. Otherwise, the process can end.

FIG. 7 is a flowchart that presents a method 700 that is useful for understanding an aspect of the present invention relating to controlling functions of a GUI. At step 702, a speed at which the appendage is moved can be detected, for instance by processing data generated by the imaging system. Continuing to step 704, a motion parameter correlating to the detected speed can be generated by the processor. Proceeding to step 706, a GUI scroll speed correlating to the motion parameter can be implemented within the GUI.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. An imaging device, comprising:
an imaging system that optically detects movement of an appendage; and
a processor that automatically translates the movement of the appendage to alphanumeric symbols or graphical user interface navigation commands, and automatically implements the alphanumeric symbols or navigation commands in an application.

2. The device of claim 1, wherein the processor further detects a speed at which the appendage is moved, and generates a motion parameter correlating to the detected speed at which the appendage is moved.

3. The device of claim 2, wherein the processor processes the motion parameter to automatically translate the movement of the appendage.

4. The device of claim 2, wherein the processor further correlates the motion parameter to a user interface scroll speed.

5. The device of claim 1, wherein the processor automatically identifies a second alphanumeric symbol in response to translating the movement of the appendage to a first of the alphanumeric symbols.

6. The device of claim 5, wherein the second alphanumeric symbol identified by the processor has a high statistical probability of following the first alphanumeric symbol.

7. The device claim 6, wherein the processor changes the second alphanumeric symbol to an alphanumeric symbol that correlates to the additional movement of the appendage that is optically detected by the imaging system

8. A machine readable storage, having stored thereon a computer program having a plurality of code sections executable by a machine for causing the machine to perform the steps of:
optically detecting movement of an appendage;
automatically translating the movement of the appendage to alphanumeric symbols or graphical user interface navigation commands; and
automatically implementing the alphanumeric symbols or navigation commands in an application.

9. The machine readable storage of claim 8, further causing the machine to perform the steps of:
detecting a speed at which the appendage is moved; and
generating a motion parameter correlating to the detected speed at which the appendage is moved.

10. The machine readable storage of claim 9, wherein the step of automatically translating the movement further comprises processing the motion parameter.

11. The machine readable storage of claim 9, wherein the step of automatically translating the movement further comprises correlating the motion parameter to a user interface scroll speed.

12. The machine readable storage of claim 8, further causing the machine to perform the step of:
responsive to translating the movement of the appendage to a first of the alphanumeric symbols, automatically identifying a second alphanumeric symbol.

13. The machine readable storage of claim 8, further causing the machine to perform the step of:
responsive to translating the movement of the appendage to a first of the alphanumeric symbols, automatically identifying a second alphanumeric symbol that has a high statistical probability of following the first alphanumeric symbol.

14. The machine readable storage of claim 13, further causing the machine to perform the step of:
responsive to optically detecting at least one additional movement of the appendage, changing the second alphanumeric symbol to an alphanumeric symbol that correlates to the additional movement.

15. A method for controlling a device having an image capture system, comprising:
optically detecting movement of an appendage;
automatically translating the movement of the appendage to alphanumeric symbols or graphical user interface navigation commands; and
automatically implementing the alphanumeric symbols or navigation commands in an application.

16. The method according to claim 15, further comprising:
detecting a speed at which the appendage is moved; and
generating a motion parameter correlating to the detected speed at which the appendage is moved.

17. The method according to claim 16, wherein the step of automatically translating the movement of the appendage further comprises processing the motion parameter.

18. The method according to claim 16, wherein the step of automatically translating the movement further comprises correlating the motion parameter to a user interface scroll speed.

19. The method according to claim 15, further comprising:
responsive to translating the movement to a first of the alphanumeric symbols, automatically identifying a second alphanumeric symbol.

20. The method according to claim 15, further comprising:
responsive to translating the movement of the appendage to a first of the alphanumeric symbols, automatically identifying a second alphanumeric symbol that has a high statistical probability of following the first alphanumeric symbol.
